(19) United States
(12) Patent Application Publication
(10) Pub. No.: US 2026/0273757 A1
(43) Pub. Date: Sep. 17, 2026

(54) OBJECT-CENTRIC SCENE REPRESENTATION FOR ROBOTIC LEARNING

(71) Applicant: Toyota Research Institute, Inc., Los Altos, CA (US)

(72) Inventors: Utkarsh A. Mishra, Atlanta, GA (US); Katherine Liu, Mountain View, CA (US); Rares A. Ambrus, San Francisco, CA (US); Sergey Zakharov, Menlo Park, CA (US); Blake Warren Wulfe, San Francisco, CA (US); Kunimatsu Hashimoto, Brookline, MA (US)

(73) Assignees: Toyota Research Institute, Inc., Los Altos, CA (US); Toyota Jidosha Kabushiki Kaisha, Toyota-shi Aichi-ken (JP)

(21) Appl. No.: 19/078,808

(22) Filed: Mar. 13, 2025

(51) Int. Cl. B25J 9/16; G06V 10/26; G06V 10/42; G06V 10/82

(52) U.S. Cl. CPC B25J 9/1697; B25J 9/161; B25J 9/163; G06V 10/26; G06V 10/42; G06V 10/82

(57) ABSTRACT

Systems, methods, and other embodiments described herein relate to uniquely representing a scene in a way that facilitates object generalization for robotic manipulation tasks. In one embodiment, a method includes collecting sensor data about an environment associated with a robotic manipulator, the sensor data including at least one image. The method includes pre-processing the sensor data to form a multi-tiered representation of the environment including image features and global features. The method includes generating an action sequence for the robotic manipulator to perform a task according to the multi-tiered representation based, at least in part, on a diffusion policy. The method includes controlling the robotic manipulator using the action sequence.

### TECHNICAL FIELD

he subject matter described herein relates, in general, to systems and methods for controlling robotic devices to perform tasks and, more particularly, to representing a scene using global and object features to facilitate scene understanding within a diffusion policy context.

### BACKGROUND

ecent advancements in dexterous manipulation have demonstrated significant progress in enabling robotic systems to perform complex tasks. However, a critical challenge remains in generalizing these skills to a broad range of unseen objects with limited data. This problem stems from the fact that, unlike text or video data that are widely accessible and abundant on the Internet, embodied data, such as that captured from physical interactions with objects, is much more costly to obtain. The scarcity of such data becomes especially problematic in low-data regimes, where the signal is high-dimensional (e.g., images) and the number of demonstrations is limited.

Existing algorithms that aim to learn robotic manipulation tasks often face difficulties when presented with variations in objects or environments that were not present during training. For instance, while some algorithms can successfully learn to place a cup on a saucer, they tend to fail when confronted with changes such as the cup’s color or shape, or when the environment varies significantly from the training setup. This results in poor generalization to new situations and a low success rate when the system encounters novel objects or conditions.

A significant aspect of this challenge is the tendency to overfit to spurious correlations in the data when there is insufficient diversity in the demonstrations. This overfitting is exacerbated when the task involves high-dimensional sensory inputs like images, where the complexity of the data makes it difficult to learn robust representations that generalize well across different scenarios.

### SUMMARY

Example systems and methods relate to uniquely representing a scene in a way that facilitates object generalization for robotic manipulation tasks. As noted previously, challenges exist in relation to generalizing dexterous manipulation of objects. In particular, the scarcity of appropriate data for training creates problems when training a robust model that can handle different types of objects. As a result, many approaches fail upon encountering previously unseen variations.

To address these limitations, there is a need for new paradigms that allow robots to learn policies capable of generalizing across a wide variety of objects without requiring exhaustive demonstrations for every possible variation. Therefore, various embodiments disclosed herein combine holistic scene-centric features with object-centric features as a visual backbone for a diffusion policy to enable better object generalization for dexterous manipulation tasks. For example, in one or more approaches, a system defines scene-level information that includes holistic information about the relationship between objects, as well as contextual information such as the environment the robot is operating in (e.g., useful for avoiding collisions/etc.) while also defining object-level information that can provide detail about specific objects that are relevant to the task. Defining the object-level information improves robustness to distractions in the scene, e.g., the color of the table is likely not relevant to the task of setting the table, and provides an abstraction that decomposes the scene into disjoint entities that are easier to reason over. In general, object-centric representations learned at scale have been trained on large datasets of 3D objects. This provides for inherently understanding 3D geometry and having well-organized latent spaces that allow for interpolation between similar objects.

Accordingly, as one example, an inventive system disclosed herein provides a unique multi-tier representation of a scene to accomplish a more robust approach. The inventive system acquires sensor data about the environment of a robotic manipulator that includes, for example, RGB-D images from multiple separate views. Thus, at each time step, the system acquires multiple images of the scene. The system extracts objects from the images via a segmentation technique (e.g., semantic segmentation). In one approach, the system uses image patches associated with the separate segmented objects to encode object features. To achieve this, the system implements, for example, an object-specific encoder that is pre-trained over a 3D object feature space, which is implemented with the intuition that the object feature space is trained over a large dataset and therefore includes information about 3D geometry of objects, not just visual appearance. This permits the feature space to adaptively change actions based on changes in the geometry of the object during inference.

Separately, the system also generates global/scene features from the original images and then combines the object features and the global features into the combined multi-tiered representation. This provides a combined scene and object representation to improve the overall representation. From this combined representation, the system generates an action sequence for the robot using a diffusion policy. In this way, the system is able to provide a generalizable robust approach and avoid difficulties with limited training sets.

In one embodiment, an interface system is disclosed. The interface system includes one or more processors and a memory communicably coupled to the one or more processors. The memory stores a control module including instructions that, when executed by the one or more processors, cause the one or more processors to collect sensor data about an environment associated with a robotic manipulator, the sensor data including at least one image. The instructions include instructions to pre-process the sensor data to form a multi-tiered representation of the environment including image features and global features. The instructions include instructions to generate an action sequence for the robotic manipulator to perform a task according to the multi-tiered representation based, at least in part, on a diffusion policy. The instructions include instructions to control the robotic manipulator using the action sequence.

In one embodiment, a non-transitory computer-readable medium including instructions that, when executed by one or more processors, cause the one or more processors to perform various functions is disclosed. The instructions include instructions to collect sensor data about an environment associated with a robotic manipulator, the sensor data including at least one image. The instructions include instructions to pre-process the sensor data to form a multi-tiered representation of the environment including image features and global features. The instructions include instructions to generate an action sequence for the robotic manipulator to perform a task according to the multi-tiered representation based, at least in part, on a diffusion policy. The instructions include instructions to control the robotic manipulator using the action sequence.

In one embodiment, a method is disclosed. The method includes collecting sensor data about an environment associated with a robotic manipulator, the sensor data including at least one image. The method includes pre-processing the sensor data to form a multi-tiered representation of the environment including image features and global features. The method includes generating an action sequence for the robotic manipulator to perform a task according to the multi-tiered representation based, at least in part, on a diffusion policy. The method includes controlling the robotic manipulator using the action sequence.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of an interface system associated with generating a novel representation of a scene in a way that facilitates object generalization for robotic manipulation tasks.

FIG. 2 illustrates one example of an image and segmented objects along with a combined multi-tiered representation.

FIG. 3 is a diagram illustrating a convolutional neural network (CNN)-based diffusion model.

FIG. 4 is a diagram illustrating a transformer-based diffusion model.

FIG. 5 illustrates an example of a feature image with embedded object information.

FIG. 6 is a flowchart illustrating one embodiment of a method for controlling a robotic device according to a novel representation of sensor data.

### DETAILED DESCRIPTION

Systems, methods, and other embodiments are disclosed associated with generating a novel representation of a scene in a way that facilitates object generalization for robotic manipulation tasks. As noted previously, challenges exist in relation to generalizing dexterous manipulation of objects. The scarcity of appropriate data for training creates problems when training a model to handle different types of objects. As a result, many approaches fail upon encountering previously unseen variations in common objects.

Therefore, various embodiments disclosed herein combine holistic scene-centric features with object-centric features as a visual backbone for a diffusion policy to enable better object generalization for dexterous manipulation tasks. In at least one approach, an interface system provides a unique multi-tier representation of a scene to accomplish a more robust approach. The interface system acquires sensor data about the environment of a robotic manipulator. The sensor data may include one or more RGB-D images from multiple separate views. Thus, at each time step, the system may acquire multiple images of the scene. The system extracts objects from the images via a segmentation technique (e.g., semantic segmentation) in order to isolate the objects from other aspects of the scene. In one approach, the system uses image patches associated with the separate segmented objects to encode object features. To achieve this, the system implements, for example, an object-specific encoder that is pre-trained over a 3D object feature space. In at least one approach, the specific object encoder benefits the system by providing an object feature space that is trained over a large dataset and therefore includes information about 3D geometry of objects, not just visual appearance. This permits the feature space to adaptively change actions based on changes in the geometry of the object during inference.

Separately, the system also generates global/scene features from the original images and then combines the object features and the global features into the combined multi-tiered representation. This provides a combined scene-object representation to improve the overall representation. From this combined representation, the system generates an action sequence for the robot using a diffusion policy. In this way, the system is able to provide a generalizable robust approach and avoid difficulties with limited training sets.

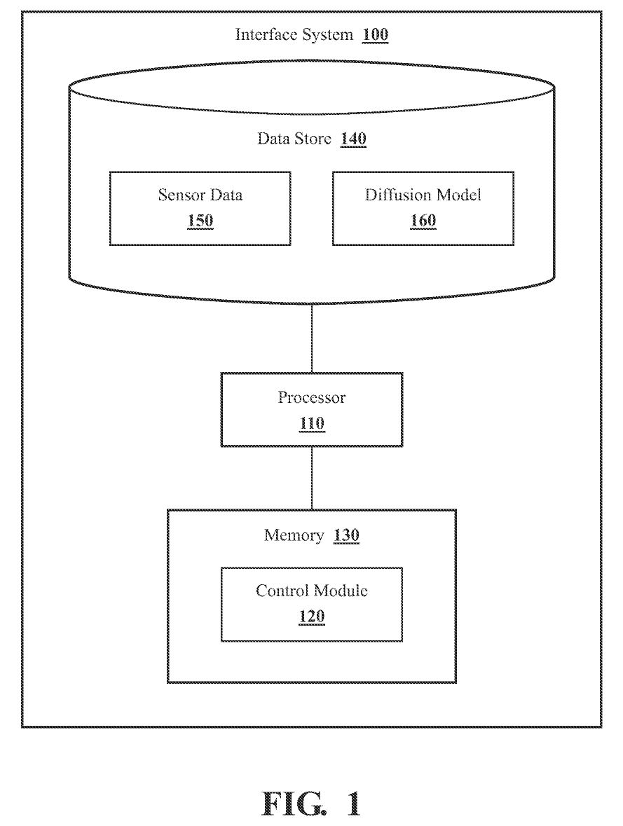

Referring to FIG. 1, one example of an interface system 100 that generates an action sequence for a robotic manipulator using a diffusion policy with a novel representation of the environment is shown. While depicted as a standalone component, in one or more embodiments, the interface system 100 is cloud-based and thus can include elements that are distributed among different locations. In general, the interface system 100 is implemented to generate action sequences for controlling a robotic manipulator. To achieve this, the interface system 100 processes sensor data that depicts an environment around the robotic manipulator and does so in a specific way to emphasize objects within the environment while still providing a complete representation. The noted functions and methods will become more apparent with a further discussion of the figures.

With further reference to FIG. 1, the interface system 100 is shown as including a processor 110. Accordingly, the processor 110 may be a part of the interface system 100, or the interface system 100 may access the processor 110 through a data bus or another communication path. In one or more embodiments, the processor 110 is an application-specific integrated circuit (ASIC) that is configured to implement functions associated with a control module 120. In general, the processor 110 is an electronic processor, such as a microprocessor, that is capable of performing various functions as described herein. In one embodiment, the interface system 100 includes a memory 130 that stores the control module 120 and/or other modules that may function in support of training and/or control. The memory 130 is a random-access memory (RAM), read-only memory (ROM), a hard disk drive, a flash memory, or other suitable memory for storing the control module 120. The control module 120 is, for example, computer-readable instructions that, when executed by the processor 110, cause the processor 110 to perform the various functions disclosed herein. In further arrangements, the control module 120 is a logic, integrated circuit, or another device for performing the noted functions that includes the instructions integrated therein.

Furthermore, in one embodiment, the interface system 100 includes a data store 140. The data store 140 is, in one arrangement, an electronic data structure stored in the memory 130 or another electronic medium, and that is configured with routines that can be executed by the processor 110 for analyzing stored data, providing stored data, organizing stored data, and so on. Thus, in one embodiment, the data store 140 stores data used by the control module 120 in executing various functions. For example, as depicted in FIG. 1, the data store 140 includes sensor data 150, and a diffusion model 160 along with, for example, other information that is used and/or produced by the control module 120. While the interface system 100 is illustrated as including the various elements, it should be appreciated that one or more of the illustrated elements may not be included within the data store 140 in various implementations. In any case, the interface system 100 stores various data elements in the data store 140 to support functions of the control module 120.

Continuing with the highlighted data elements, the sensor data 150 includes, for example, information collected from sensors associated with a particular device. That is, in various implementations, the content of the sensor data 150 depends on the sensors implemented by the particular device. In the context of a robotic manipulator, the sensor data 150 includes, for example, images of the environment of the robotic manipulator. The images may be from sensors mounted to the robotic manipulator or statically mounted in the environment. In at least one arrangement, the images are from separate viewpoints of the environment in order to provide a multi-view representation. Of course, while a multi-view representation is described, in further arrangements, a single-view representation (i.e., a single image per timestep) can be used. Moreover, the images are acquired at separate timesteps. That is, the interface system 100 iteratively acquires the images at a predefine rate (e.g., every 0.03s). The images themselves are generally RBG-D images, meaning that the separate pixels within the image are encoded with red, green, and blue visual data while also including depth information (i.e., a distance to the source camera).

While images are generally described as the primary aspect of the sensor data 150, in further arrangements, the sensor data 150 may include additional information, such as manipulator position information, kinematics data, pose data for an end-effector of the manipulator, IMU data, ultrasonic sensor data, LiDAR data, radar data, force feedback data, and so on. Accordingly, the sources may vary beyond images; however, the present discussion focuses on images as one example of the sensor data 150. In any case, the control module 120 includes instructions to collect and process the sensor data 150.

That is, the control module 120 may directly controls one or more sensors that generate the sensor data 150 or passively acquires the sensor data 150 by, for example, sniffing the sensor data 150 from a system bus or other communication pathway. The control module 120, in one configuration, then pre-processes the sensor data 150. The control module 120 may pre-process the sensor data 150 by, for example, segmenting the objects within the images. To segment the images, the control module 120, in one arrangement, applies a model that performs semantic segmentation in which each pixel of an image is classified as belonging to a particular object class. In further arrangements, the control module 120 applies an object recognition model that is trained to recognize various objects. In either case, the result is the identification of objects present within the environment. This identification may include information beyond a simple classification. For example, the information may include a boundary (e.g., a bounding box or specific boundary/position). The bounding box may define coordinates for the corners of a rectangle that define an area of the object.

Using this position information, the control module 120 can extract image patches of just the objects from the images. That is, an area in an image associated with an object is separated from the image to define an image patch corresponding with the object alone. The control module 120 generates an image patch for each separate object within each separate image to provide object-specific information. The control module 120 then processes the image patches with an object-specific encoder. The object-specific encoder is, for example, a machine learning algorithm, such as a convolutional neural network (CNN), that functions to generate an encoded representation of the object as depicted in the image patch for each separate object. The object-specific encoder outputs, in at least one arrangement, a feature vector describing the object.

Separately, the control module 120 may also encode global features. That is, in contrast to encoding a single object alone, as in the case of each of the object-specific encodings, the control module 120 processes the whole image using a separate global encoder. Again, the global encoder is a machine-learning algorithm (e.g., a CNN) that processes the image into a set of features, which may take the form of a feature vector. Thus, the control module 120 processes both the objects and the whole scene into feature representations. Once the control module 120 processes all of the images, the features are combined.

In one approach, the control module 120 combines the feature vectors for the objects and the scene together. The control module 120 may further combine additional information, when available, such as bounding box coordinates, position information, etc. In any case, the combined feature embeddings form a multi-tiered representation of the scene that emphasizes the objects through the specific object encodings.

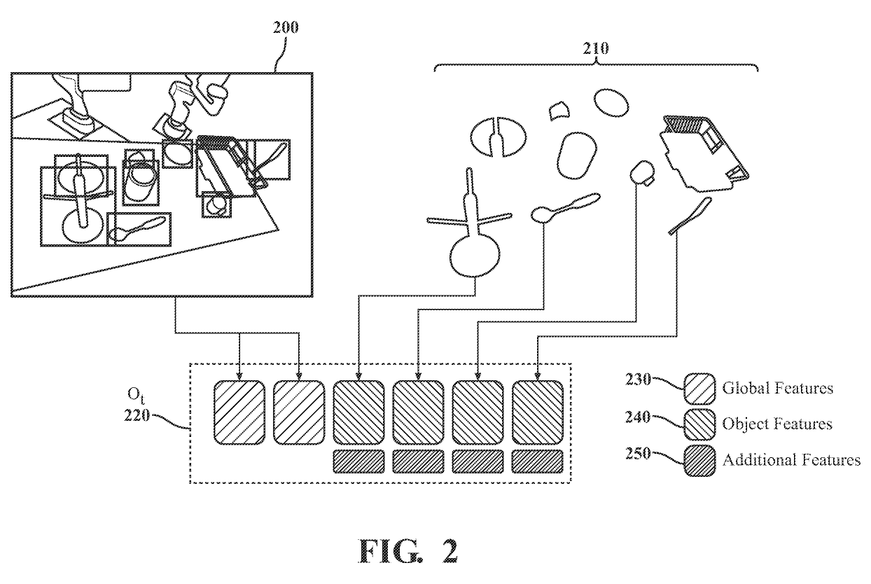

As one example of the separate features and the combined representation, consider FIG. 2. FIG. 2 illustrates one example of an image 200, as may be included in the sensor data 150. As illustrated, the objects within the image 200 are identified, as represented by the bounding boxes, and extracted into separate image patches 210. Ot represents the combined multi-tiered feature representation 220 for a timestep t that is for the image 200. As illustrated, the representation 200 includes global features 230, object features 240, and additional features 250 (e.g., bounding box coordinates, positional embeddings, etc.). Thus, the control module 120 extracts the features from the image 200 and the image patches 210 and then combines them into the representation 220. It should be noted that for purposes of this description, the image patches 210 represent the objects as silhouettes without detail; however, the image patches 210, in practice, include the detail represented in the image 200.

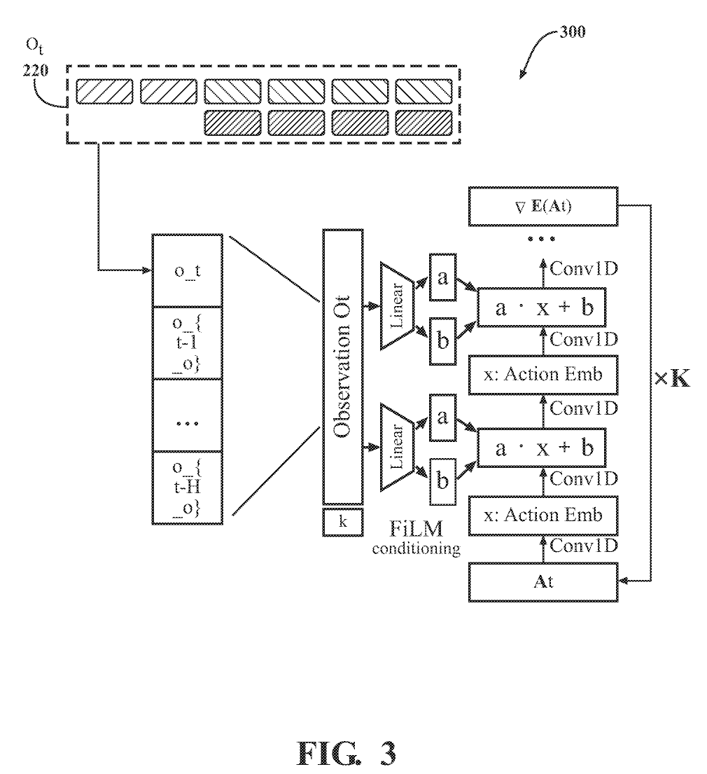

The control module 120 then uses the representation 220 as an input to a diffusion policy/model. The diffusion model 160 may take different forms depending on the implementation and, thus, the particular form of the representation 220 may also vary to accommodate the specific implementation. The separate approaches for the diffusion model 160 will be described along with FIGS. 3-5. FIG. 3 illustrates a CNN-based implementation 300 of the diffusion model 160. As shown in this example, the current representation 200 of the present time step is provided as an input to the model 300 along with one or more prior inputs Ot-H, where H is an integer value indicating the number of prior timesteps provided along with the current time step as inputs.

The interface system 100 may implement the CNN-based diffusion policy 300 to learn a linear projection of the object features from the input. In particular, the control module 120 may project the object features 240 into a smaller latent space and concatenate the object features 240 with the global features 230 (and the additional features 250) before passing the features to the CNN-based diffusion policy 300. In general, the control module 120 may define a maximum number of objects that are expected to be seen in the scene, and if there are fewer objects than the maximum number, then the remaining embedding placeholders are set to null values in order to define an input of known dimensions.

To initially generate the lower dimensional embedding, the control module 120 may implement various routines. For example, in one approach, the control module 120 projects each object feature/latent to a lower dimensional feature vector describing the object. This linear projection may or may not include the bounding box. These latent features can be concatenated together to form a single latent feature. Separately, the control module 120 may concatenate all of the object features together first, then project the concatenated features to a lower dimensional feature. In still a further approach, the control module 120 concatenates together features that are repeated between multiple images for the same object. That is, when an object is perceived within multiple images for the same timestep, the control module 120 may combine the features together, including bounding boxes, and project the features into a lower dimension to obtain one embedding for each object.

In any case, the CNN-based diffusion policy 300 is comprised of a plurality of convolutional layers that function to further encode the input and ultimately output through a final classification layer, an action sequence for controlling the robotic manipulator. In at least one arrangement, the CNN-based diffusion policy 300 accepts a history of observations (images from single/multiple cameras) as inputs and uses features from the images to condition the denoising process of actions via Feature-wise linear modulation (FiLM). The policy 300 repeats this step throughout the denoising process and ultimately outputs through a final regression layer, an action sequence for controlling the robotic manipulator.

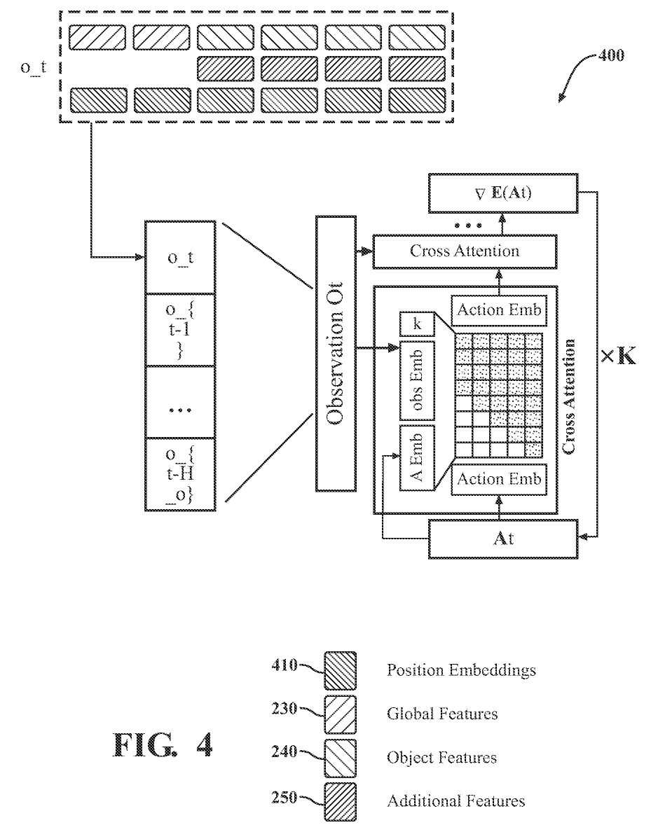

FIG. 4 illustrates a further embodiment of the diffusion model 160. As shown in FIG. 4, the diffusion model 160 is a transformer-based model 400. Here, the model 400 learns linear projections of the object features 240 that include the bounding boxes, as the additional features 250, and position embeddings 410, which may take the form of pixel coordinates. The model 400 further learns linear projections of the global features 230, including respective positional encodings, such that the global features 230 have the same feature dimension. Each of the features is then considered a token and passed to the model 400. Moreover, the control module 120 may obtain the latent feature of each object by fusing the information from available camera images to combine features for repetitive instances of the same object. As for the architecture of the model 400 itself, the model 400 is a diffusion-based model that is comprised of a transformer architecture. In one aspect, a key distinction from the CNN-based diffusion policy 300 is the addition of cross attention between the observation features and the noisy action embeddings. The model 400 repeats the cross-attention module throughout the denoising process and outputs the actions.

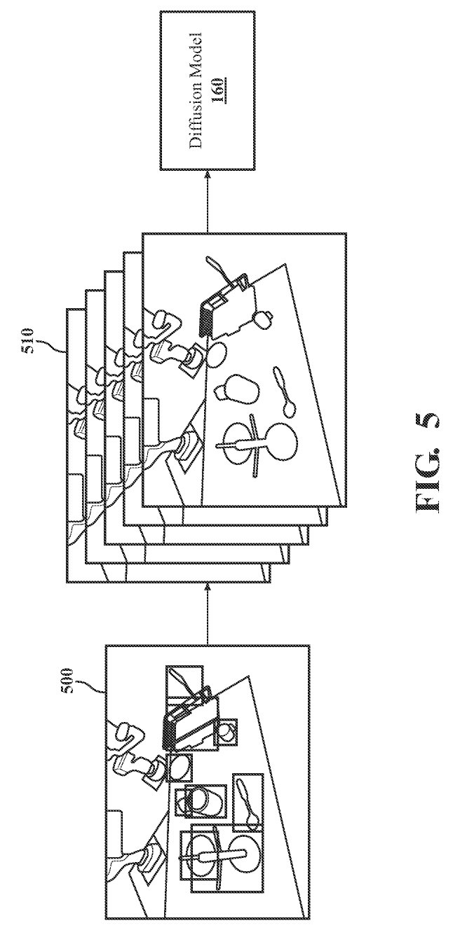

Referring to FIG. 5, an image-based approach to generating the multi-tiered representation of features is illustrated. As shown, an image 500 is acquired about the environment. The image 500 includes depictions of multiple separate objects. In this approach, the control module 120 extracts the objects and generates the object features. The control module 120 then replaces the pixels in the image 500 that correspond with the objects with the generated features. The control module 120 then passes the resulting feature image 510 to the diffusion model 160, which may be the CNN-based diffusion model 300 or another implementation that can process the image-based input.

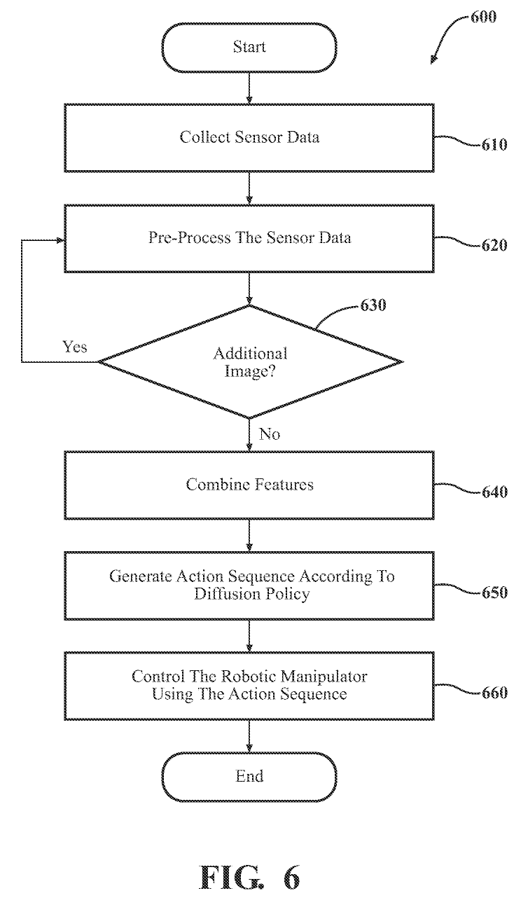

Additional aspects of generating a novel representation of a scene in a way that facilitates object generalization for robotic manipulation tasks will be discussed in relation to FIG. 6. FIG. 6 illustrates a flowchart of a method 600 that is associated with pre-processing sensor data into a combined multi-tiered representation. Method 600 will be discussed from the perspective of the interface system 100 of FIG. 1. While method 600 is discussed in combination with the interface system 100, it should be appreciated that the method 600 is not limited to being implemented within the interface system 100 but is instead one example of a system that may implement the method 600.

At 610, the control module 120 collects the sensor data 150. As indicated previously, the sensor data 150 indicates aspects about the robotic manipulator within an environment in which the device is operating. In general, the control module 120 collects the sensor data 150 from sensors associated with the robotic device, such as a camera mounted in the environment (e.g., statically or on the device), position sensors, and so on. Thus, the sensor data 150 generally includes at least images of an area in which the robotic manipulator is operating and, in particular, of the end-effector/gripper of the device. Moreover, the sensors may include multiple separate cameras within the environment that provide distinct views. Accordingly, for each separate time step, in at least one configuration, the control module 120 collects multiple separate images. Each of the images may provide multiple separate channels of information, including multiple color channels (e.g., RGB) and a depth channel. The depth channel may be explicitly provided via the camera or may be derived using monocular depth estimation or another technique.

At 620, the control module 120 pre-processes the sensor data 150. As described herein, pre-processing the sensor data 150 may include multiple separate steps as described at 620-640 of method 600. Thus, initially, the control module 120 segments objects depicted in an image to extract image patches. As previously outlined, the images patches are portions of the image specific to the objects. Thus, an area depicted in the image that includes a specific object is extracted as an image patch for that object. In general, the image patch includes only the specific object as a one-to-one correspondence without depicting other objects.

In various arrangements, to support the use of segmentation over the collected images, the control module 120 uses a tracking method, such as SAM-Track. Applying the tracking method speeds up the object detection/segmentation component of the pre-processing. To achieve this, the control module 120 uses, in one arrangement, a detect-and-track algorithm, where the objects depicted in the image are detected only once every N frames. Otherwise, the control module 120 must detect the objects at every frame, and, as a consequence, slow down the pre-processing. Thus, implementing the tracking approach facilitates real-time analysis. In one arrangement, the control module 120 initializes tracking by specifying the objects to be tracked in the first frame via, for example, an explicit input or an automatic selection according to an object detection routine. The control module 120 can then track the objects between successive images without performing explicit object detection in order to conserve computing resources and improve processing time. Alternatively, the control module 120 can instead implement other approaches, such as semantic segmentation to identify the objects within each separate image.

Once the control module 120 segments or otherwise identifies the objects and generates the image patches for the objects, the control module 120 proceeds with encoding the objects into object features. In general, the control module 120 utilizes an object-specific encoder that is, for example, a machine learning algorithm trained on a broad ontology of objects. In this way, the object-specific encoder is able to recognize distinct aspects between similar objects and generate the feature vectors for the objects accordingly. Similarly, in at least one configuration, the control module 120 also encodes global features by processing the original image with a global encoder that is trained on whole images. As a result, the control module 120 provides features for the image as a whole in the form of the global features and also object features that are specific to each separate object.

At 630, the control module 120 determines whether additional images are available. That is, when the sensor data 150 includes multiple separate views of the environment about the robotic device, the control module 120 repeats the pre-processing at 620 in order to generate object and global features for all of the images that are to be processed. Thus, the control module 120 iteratively pre-processes the images. Accordingly, when no further images are available, the control module 120 proceeds to combine the features as described at block 640.

At 640, the control module 120 combines the global features and the object features into the multi-tiered representation. In at least one arrangement, the control module 120 concatenates the global features and the object features together into, for example, a string of feature vectors. In various arrangements, this may further include concatenating additional information that is available about the objects, such as bounding boxes and/or positional embeddings. In any case, multiple tiers of information is combined into a single representation. Of course, as described in relation to FIGS. 3-5, the exact manner in which the features are combined can vary depending on the specific implementation.

At 650, the control module 120 generates an action sequence for the robotic manipulator to perform a task according to the multi-tiered representation of the sensor data 150 using the diffusion model 160. In general, the control module 120 generates the actions as a sequence of synchronized end-effector poses and gripper widths through a defined period of time. Thus, the actions provide a sequence of movements for the robotic manipulator to achieve the task. As outlined previously, the diffusion model 160 may take different forms depending on the implementation, including a convolutional neural network (CNN)-based diffusion model, a transformer-based diffusion model, etc. Thus, the separate implementations of the diffusion model 160 generally accept slightly different forms of the multi-tiered representation as specified in relation to FIGS. 3-5. Whichever form of the diffusion model 160 is implemented, the input may vary slightly in form but is still focused on highlighting the objects through specific object-centric embeddings that the diffusion model 160 processes in combination with, for example, prior inputs in order to integrate temporal information concerning the prior states of the environment. In any case, the action sequence is, in at least one approach, a sequence of controls for a bi-manual robot manipulator that includes, for example, a left and a right wrist. Thus, the interface system 100 is able to control the robotic manipulator using the action sequence or at least derive controls from the action sequence.

At 660, the control module 120 controls the robotic manipulator using the generated action sequence. It should be noted that the present approach can be implemented for inference and/or for imitation learning. In regards to imitation learning, the system may score the output according to a score-matching objective that provides for deriving a loss value that is used to train the diffusion model 160. In this case, the imitation learning is directed to a single known/implicit task, such as picking up a cup and putting it on a plate. Moreover, the training regime may also integrate noisy inputs, such as a noisy manipulator action as a further input to the diffusion model 160.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the Figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase "computer-readable storage medium" means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions. The term "operatively connected" and “communicatively coupled,” as used throughout this description, can include direct or indirect connections, including connections without direct physical contact.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the "C" programming language or similar programming languages. The program code may execute entirely on the user's computer, partly on the user's computer, as a standalone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms "a" and "an," as used herein, are defined as one or more than one. The term "plurality," as used herein, is defined as two or more than two. The term "another," as used herein, is defined as at least a second or more. The terms "including" and/or "having," as used herein, are defined as comprising (i.e., open language). The phrase "at least one of … and …." as used herein refers to and encompasses any and all possible combinations of one or more of the associated listed items. As an example, the phrase "at least one of A, B, and C" includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An interface system, comprising:
one or more processors;
a memory communicably coupled to the one or more processors and storing instructions that cause the one or more processors to:
collect sensor data about an environment associated with a robotic manipulator, the sensor data including at least one image;
pre-process the sensor data to form a multi-tiered representation of the environment including image features and global features;
generate an action sequence for the robotic manipulator to perform a task according to the multi-tiered representation based, at least in part, on a diffusion policy; and
control the robotic manipulator using the action sequence.

2. The interface system of claim 1, wherein the instructions to pre-process the sensor data include instructions to:
segment objects depicted in the image to extract image patches including separate ones of the objects;
generate global features and object features for the image; and
combine the global features and the object features into the multi-tiered representation.

3. The interface system of claim 2, wherein the instructions to combine the global features and the object features include instructions to concatenate the global features and the object features together along with additional information about one or more of bounding boxes or positional embeddings.

4. The interface system of claim 2, wherein the instructions to generate the global features include instructions to apply a global encoder to the image to encode the global features as a global feature vector and generating the object features includes applying an object encoder to the image patches separately to generate object feature vectors, and
wherein the global features represent a scene as a whole and the object features separately represent the objects.

5. The interface system of claim 1, wherein the diffusion policy is one of: a convolutional neural network (CNN)-based diffusion model, or a transformer-based diffusion model,
wherein the instructions to generate the action sequence include instructions to provide the multi-tiered representation that separately captures global features, and object features for a current time step to the diffusion policy along with at least a prior multi-tiered representation for a previous time step.

6. The interface system of claim 1, wherein the image includes four separate channels including a depth channel and multiple color channels, and
wherein the sensor data includes four images that capture the environment from separate distinct views.

7. The interface system of claim 1, wherein the instructions to pre-process include instructions to iteratively pre-process the images and combine global features and object features from the images into the multi-tiered representation.

8. The interface system of claim 1, wherein the robotic manipulator is a bi-manual robot manipulator with a left wrist and a right wrist, and wherein the action sequence specifies a sequence of controls for the bi-manual manipulator to achieve a task.

9. A non-transitory computer-readable medium including instructions that, when executed by one or more processors, cause the one or more processors to:
collect sensor data about an environment associated with a robotic manipulator, the sensor data including at least one image;
pre-process the sensor data to form a multi-tiered representation of the environment including image features and global features;
generate an action sequence for the robotic manipulator to perform a task according to the multi-tiered representation based, at least in part, on a diffusion policy; and
control the robotic manipulator using the action sequence.

10. The non-transitory computer-readable medium of claim 9,
wherein the instructions to pre-process the sensor data include instructions to:
segment objects depicted in the image to extract image patches including separate ones of the objects;
generate global features and object features for the image; and
combine the global features and the object features into the multi-tiered representation.

11. The non-transitory computer-readable medium of claim 10, wherein the instructions to combine the global features and the object features include instructions to concatenate the global features and the object features together along with additional information about one or more of bounding boxes or positional embeddings.

12. The non-transitory computer-readable medium of claim 10, wherein the instructions to generate the global features include instructions to apply a global encoder to the image to encode the global features as a global feature vector and generating the object features includes applying an object encoder to the image patches separately to generate object feature vectors, and
wherein the global features represent a scene as a whole and the object features separately represent the objects.

13. The non-transitory computer-readable medium of claim 9, wherein the diffusion policy is one of: a convolutional neural network (CNN)-based diffusion model, or a transformer-based diffusion model,
wherein the instructions to generate the action sequence include instructions to provide the multi-tiered representation that separately captures global features, and object features for a current time step to the diffusion policy along with at least a prior multi-tiered representation for a previous time step.

14. A method, comprising:
collecting sensor data about an environment associated with a robotic manipulator, the sensor data including at least one image;
pre-processing the sensor data to form a multi-tiered representation of the environment including image features and global features;
generating an action sequence for the robotic manipulator to perform a task according to the multi-tiered representation based, at least in part, on a diffusion policy; and
controlling the robotic manipulator using the action sequence.

15. The method of claim 14, wherein pre-processing the sensor data includes:
segmenting objects depicted in the image to extract image patches including separate ones of the objects;
generating global features and object features for the image; and
combining the global features and the object features into the multi-tiered representation.

16. The method of claim 15, wherein combining the global features and the object features includes concatenating the global features and the object features together along with one or more of bounding boxes or positional embeddings.

17. The method of claim 15, wherein generating the global features includes applying a global encoder to the image to encode the global features as a global feature vector and generating the object features includes applying an object encoder to the image patches separately to generate object feature vectors, and
wherein the global features represent a scene as a whole and the object features separately represent the objects.

18. The method of claim 14, wherein the diffusion policy is one of: a convolutional neural network (CNN)-based diffusion model, a transformer-based diffusion model, or an image-feature based model,
wherein generating the action sequence includes providing the multi-tiered representation that separately captures global features, and object features for a current time step to the diffusion policy along with at least a prior representation for a previous time step.

19. The method of claim 14, wherein the image includes four separate channels including a depth channel and multiple color channels, and
wherein the sensor data includes four images that capture the environment from separate distinct views.

20. The method of claim 14, wherein pre-processing includes iteratively pre-processing the images and combining global features and object features from the images into the multi-tiered representation.
